(19) United States
(12) Patent Application Publication
(10) Pub. No.: US 2023/0176495 A1
(43) Pub. Date: Jun. 8, 2023

(54) PIGMENT DISPERSION AND TONER

(71) Applicant: CANON KABUSHIKI KAISHA, Tokyo (JP)

(72) Inventors: YU YOSHIDA, Shizuoka (JP); DAI NOZAKI, Shizuoka (JP); HARUMI TAKADA, Shizuoka (JP); SHIRO KUROKI, Shizuoka (JP); NORITAKA TOYOIZUMI, Shizuoka (JP); SHINSUKE MOCHIZUKI, Kanagawa (JP)

(21) Appl. No.: 18/058,948

(22) Filed: Nov. 28, 2022

(30) Foreign Application Priority Data
Dec. 3, 2021 (JP) 2021-197360

(51) Int. Cl. G03G 9/09; G03G 9/087; G03G 9/08

(52) U.S. Cl. CPC G03G 9/0926; G03G 9/0819; G03G 9/0902; G03G 9/08755

(57) ABSTRACT

The pigment dispersion is a pigment dispersion including a fluorescent agent, wherein, when at a wavelength of 250 nm or more and 290 nm or less, an integral value of an emission intensity in a wavelength range of 400 nm or more and 700 nm or less of an emission spectrum of the fluorescent agent for excitation light is represented by F1, an integral value of an emission intensity in a wavelength range of 400 nm or more and 700 nm or less of an emission spectrum of the pigment dispersion for excitation light is represented by F2, and a ratio of the fluorescent agent contained in a solid content obtained when the pigment dispersion is heated at 130° C. until a change in mass of the pigment dispersion reaches 0.3%/min or less is represented by W1 (mass%), the F1, the F2, and the W1 satisfy the formulae F2x 100/W1≥F1 ×0.30 and 5.0≤W1≤80.0.

### BACKGROUND OF THE INVENTION

### Field of the Invention

The present invention relates to a pigment dispersion and a toner.

### Description of the Related Art

In recent years, the distribution of counterfeit products has become a problem in various product forms. As countermeasures against this problem, information that cannot be recognized under visible light (invisible information) is being embedded.

In Japanese Patent Application Laid-Open No. 2000-144029, as a method of improving security through use of invisible information, there is a disclosure of a method involving forming an invisible image by blending a material that emits fluorescence in a visible light range when irradiated with UV light into a paint, ink, an electrophotographic toner, or the like. However, the currently disclosed technology for imparting security is insufficient, and hence there is a demand for the development of a further advanced technology for imparting security. In addition, the light fastness of an invisible image is required in items that need to be stored for a long period of time.

### SUMMARY OF THE INVENTION

It is an object of the present invention to solve the above-mentioned problem, that is, to provide a pigment dispersion and a toner capable of forming an image having high security and further having satisfactory light fastness.

A first aspect of the present invention is a pigment dispersion including a fluorescent agent and a binder resin, wherein the fluorescent agent is excited with light at a wavelength of 400 nm or less, wherein, when an integral value of an emission intensity in a wavelength range of 400 nm or more and 700 nm or less of an emission spectrum of the fluorescent agent for excitation light at a wavelength of 250 nm or more and 290 nm or less is represented by F1, an integral value of an emission intensity in a wavelength range of 400 nm or more and 700 nm or less of an emission spectrum of the pigment dispersion for excitation light at a wavelength of 250 nm or more and 290 nm or less is represented by F2, and a ratio of the fluorescent agent contained in a solid content obtained when the pigment dispersion is heated at 130° C. until a change in mass of the pigment dispersion reaches 0.3%/min or less is represented by W1 (mass%), the F1, the F2, and the W1 satisfy the following formulae (1) and (2).

$$\text{F2} \times \text{100/W1} \text{} \geq \text{} \text{F1} \times \text{0} \text{.30}$$

$$5.0 \leq \text{W1} \leq \text{80} \text{.0}$$

A second aspect of the present invention is a toner including a toner particle containing a fluorescent agent that is excited with light at a wavelength of 400 nm or less, a binder resin, and a release agent, wherein, when an integral value of an emission intensity in a wavelength range of 400 nm or more and 700 nm or less of an emission spectrum of the fluorescent agent for excitation light at a wavelength of 250 nm or more and 290 nm or less is represented by F3, an integral value of an emission intensity in a wavelength range of 400 nm or more and 700 nm or less of an emission spectrum of the toner for excitation light at a wavelength of 250 nm or more and 290 nm or less is represented by F4, and a mass ratio of the fluorescent agent in the toner particle is represented by W2 (mass%), the following formulae (7) and (8) are satisfied.

$$\text{F4} \times \text{100/W2} \geq \text{F3} \times \text{0} \text{.30}$$

$$5.0 \leq \text{W2} \leq \text{80} \text{.0}$$

According to the present invention, the pigment dispersion and the toner capable of forming an image having high security and having satisfactory light fastness can be provided.

Further features of the present invention will become apparent from the following description of exemplary embodiments.

### DESCRIPTION OF THE EMBODIMENTS

A pigment dispersion and a toner of the present invention are specifically described.

A pigment dispersion of the present invention is a pigment dispersion including a fluorescent agent and a binder resin, wherein the fluorescent agent is excited with light at a wavelength of 400 nm or less, wherein, when an integral value of an emission intensity in a wavelength range of 400 nm or more and 700 nm or less of an emission spectrum of the fluorescent agent for excitation light at a wavelength of 250 nm or more and 290 nm or less is represented by F1, an integral value of an emission intensity in a wavelength range of 400 nm or more and 700 nm or less of an emission spectrum of the pigment dispersion for excitation light at a wavelength of 250 nm or more and 290 nm or less is represented by F2, and a ratio of the fluorescent agent contained in a solid content obtained when the pigment dispersion is heated at 130° C. until a change in mass of the pigment dispersion reaches 0.3%/min or less is represented by W1 (mass%), the F1, the F2, and the W1 satisfy the following formulae (1) and (2). The pigment dispersion may contain a solvent, and hence the term “solid content” is used herein in order to exclude the case in which the pigment dispersion contains a solvent.

$$\text{F2} \times \text{100/W1} \geq \text{F1} \times \text{0} \text{.30}$$

$$5.0 \leq \text{W1} \leq \text{80} \text{.0}$$

The fluorescent agent according to the present invention is excited with light at a wavelength of 400 nm or less, that is, UV light, and has an emission spectrum in a visible light range. Because of this, the fluorescent agent can form an image that is made visible to the human eye by irradiation with UV light. Further, the security can be further improved by using, as excitation light, light at a wavelength of 290 nm or less among light at a wavelength of 400 nm or less.

In image formation, a binder resin is often blended when a coloring material (dye or pigment) is immobilized on a medium. A general binder resin has absorption in a wavelength range of 250 nm or more and 290 nm or less in many cases. When an image is irradiated with excitation light in this wavelength range, the excitation light may be absorbed by the binder resin, resulting in a decrease in emission efficiency. It is conceived that, in the case where the pigment dispersion of the present invention satisfies the formula (1), even when excitation light in a wavelength range of 250 nm or more and 290 nm or less is radiated, a decrease in emission efficiency can be reduced, and hence the visibility at the time of irradiation with UV light can be increased.

Further, the pigment dispersion of the present invention has a feature of satisfying the formula (2). When the W1 is 5.0 or more, the visibility can be improved. In addition, when the W1 is 80.0 or less, the granularity of an image can be reduced, and hence the invisibility can be expressed at the time of irradiation with visible light. It is preferred that the W1 further satisfy the following formula (3).

$$30.0 \leq \text{W1} \leq \text{70} \text{.0}$$

It is preferred that a maximum value (Rmax1) of a light absorptivity in the wavelength range of 400 nm or more and 700 nm or less in an image of the solid content formed of the pigment dispersion of the present invention on a medium at a laid-on level of 0.3 mg/cm² be 10% or less.

When the above-mentioned conditions are satisfied, the invisibility of an image is improved. The light absorptivity in the wavelength range of 400 nm or more and 700 nm or less may be controlled by changing the particle diameter of the fluorescent agent, the ratio W1 of the fluorescent agent contained in the solid content, or the spectrum of the binder resin in the wavelength of 400 nm or more and 700 nm or less.

It is preferred that, when color coordinates obtained by transforming emission wavelength spectra of the pigment dispersion of the present invention at the time of irradiation with excitation light in a wavelength range of 250 nm or more and 290 nm or less and a wavelength range of 315 nm or more and 400 nm or less into an L*a*b* color system are represented by G1 and G2, respectively, a difference ΔE1 between the color coordinates G1 and G2 be 20.0 or more. When an image emits light in two kinds of colors at two kinds of different excitation wavelengths of UV light (two-excitation two-color emission), the security of the image can be improved. When the ΔE1 is 20.0 or more, two-color emission is easily recognized, and the security can be improved. The range of the ΔE1 is more preferably 30.0 or more. The ΔE1 may be changed also by changing the kind of the fluorescent agent, a metal contained in the fluorescent agent, or the production conditions of the fluorescent agent.

The pigment dispersion may be solvent-free or may contain various solvents as required.

The solvent to be used in the pigment dispersion is not particularly limited as long as the solvent is an organic solvent in which the binder resin is dissolved. Specific examples of the organic solvent include: ketones, such as methyl ethyl ketone and methyl isobutyl ketone; esters, such as ethyl acetate and isobutyl acetate; cyclic saturated hydrocarbons, such as cyclohexane and cycloheptane; cyclic ethers such as tetrahydrofuran; and aromatic hydrocarbons, such as toluene and xylene. Those organic solvents may be used alone or as a mixture thereof.

A known method may be used as a method of producing the pigment dispersion. For example, the pigment dispersion may be produced by dispersing a fluorescent agent, a binder resin, and a solvent as required through use of a disperser, such as a bead mill, a roll mill, or a media-less disperser.

The fluorescent agent according to the present invention is described in detail below.

The fluorescent agent according to the present invention is not particularly limited as long as the fluorescent agent is excited with light at a wavelength of 400 nm or less and has an emission spectrum for excitation light at a wavelength of 250 nm or more and 290 nm or less.

It is preferred that the fluorescent agent be a pigment in a pigment dispersion or a toner. When the fluorescent agent is pigmented, the light fastness of a formed image is improved. The pigment in the present invention refers to a state in which the fluorescent agent is present as particles in the pigment dispersion or the toner. The state of the presence as the particles may be recognized by a method involving observing the cross-section of an image film obtained from the pigment dispersion or the toner with a scanning electron microscope (SEM) or a transmission electron microscope (TEM).

The following fluorescent agents may each be used as the fluorescent agent.

There may be used, for example, fluorescent colorants, such as thiophene-based, β-quinophthalone-based, coumarin-based, bisstyrylbenzene-based, and oxazole-based colorants, europium-based complex compounds, and inorganic compounds, such as calcium fluoride, and a tungstic acid salt, an arsenic acid salt, a silicic acid salt, and a phosphoric acid salt of an alkaline earth metal, such as calcium tungstate, barium silicate, calcium phosphate, and calcium zinc phosphate. The inorganic compounds may each have another kind of metal element as required.

The fluorescent agent is preferably an inorganic compound containing a lanthanoid element and containing calcium fluoride as a main component out of those inorganic compounds. Through use of the inorganic compound containing a lanthanoid element and containing calcium fluoride as a main component, satisfactory light fastness can be obtained.

In the present invention, in order to improve the security of an image, it is preferred that the image emit light in two kinds of colors at two kinds of different excitation wavelengths of UV light (two-excitation two-color emission). When the fluorescent agent according to the present invention is an inorganic compound containing a lanthanoid element and containing calcium fluoride as a main component, the two-excitation two-color emission is easily expressed, and hence the security is easily improved. It is particularly preferred that the fluorescent agent contain europium (Eu) among the lanthanoid elements.

It is preferred that, in a sectional observation image of the image film obtained from the pigment dispersion or the toner, the fluorescent agent have a 50% particle diameter on a number basis of 500 nm or less. When the 50% particle diameter on a number basis is 500 nm or less, the granularity of the image is reduced, and hence the invisibility is easily improved. The 50% particle diameter on a number basis falls within a range of more preferably 400 nm or less, still more preferably 300 nm or less. The particle diameter of the fluorescent agent may be controlled by, for example, the dispersion conditions of the pigment. In addition, from the viewpoint of improving the light fastness, it is preferred that the particle diameter of the fluorescent agent be 50 nm or more.

Next, the binder resin according to the present invention is described in detail.

It is preferred that the binder resin according to the present invention contain one or more kinds of units selected from units each represented by any one of the following formulae (4) to (6), and the total content ratio of the units each represented by any one of the formulae (4) to (6) in the total mass of the binder resin be 70 mass% or more:

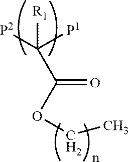

in the formula (4), P¹ and P² each represent a bonding site to a main chain skeleton of a resin, R₁ represents a hydrogen atom or a methyl group, and “n” represents an integer of 0 or more and 30 or less;

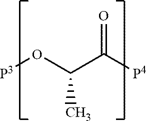

in the formula (5), P³ and P⁴ each represent a bonding site to the main chain skeleton of the resin;

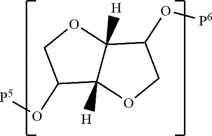

in the formula (6), P⁵ and P⁶ each represent a bonding site to the main chain skeleton of the resin.

When the above-mentioned requirements are satisfied, the absorption of UV excitation light by the binder resin can be reduced, and hence the visibility at the time of irradiation with UV light can be improved. The case in which the binder resin contains the unit represented by the formula (4) and the “n” in the formula (4) is 16 or more and 30 or less is preferred because the structure of the formula (4) is easily crystallized, and the light fastness is improved.

The kind of the resin that may be used for the binder resin is not particularly limited, and examples thereof include polyester, a vinyl-based resin, polyurethane, polyurea, polycarbonate, a phenol resin, polyolefin, and an epoxy resin.

As a method of introducing the unit represented by the formula (4) into a polymer, there is given a method involving polymerizing an acrylic monomer described below.

Examples of the acrylic monomer include methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, n-dodecyl acrylate, tetradecyl acrylate, n-stearyl acrylate, n-behenyl acrylate, nonadecyl acrylate, eicosyl acrylate, heneicosanyl acrylate, ceryl acrylate, octacosa acrylate, myricyl acrylate, methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, n-dodecyl methacrylate, tetradecyl methacrylate, n-stearyl methacrylate, n-behenyl methacrylate, nonadecyl methacrylate, eicosyl methacrylate, heneicosanyl methacrylate, ceryl methacrylate, octacosa methacrylate, and myricyl acrylate.

In addition, the monomer may be copolymerized with any other monomer having an ethylenically unsaturated bond as required. Examples of the copolymeirzable monomer include styrene, α-methylstyrene, β-methylstyrene, o-methylstyrene, m-methylstyrene, p-methylstyrene, 2,4-dimethylstyrene, p-n-butylstyrene, p-tert-butylstyrene, maleic acid, acrylic acid, methacrylic acid, acrylonitrile, methacrylonitrile, vinyl acetate, and 2-hydroxyethyl methacrylate.

As a method of introducing the unit represented by the formula (5) into a polymer, polylactic acid may be used as a part or an entirety of the binder resin. As a method of synthesizing polylactic acid, there is given, for example, a method involving subjecting L-lactide that is a cyclic dimer of lactic acid to ring-opening polymerization through use of an initiator in the presence of a catalyst.

As a method of introducing the unit represented by the formula (6) into a polymer, isosorbide and a monomer capable of condensation polymerization therewith may be subjected to condensation polymerization to provide the unit introduced into the polymer. Specific examples thereof include polyvalent carboxylic acids, such as oxalic acid, glutaric acid, succinic acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-dicarboxylic acid, hexahydroterephthalic acid, malonic acid, pimelic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediglycolic acid, p-phenylenediglycolic acid, o-phenylenediglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid. In addition, examples of the polyvalent carboxylic acid other than the dicarboxylic acid include trimellitic acid, pyromellitic acid, naphthalenetricarboxylic acid, naphthalenetetracarboxylic acid, pyrenetricarboxylic acid, and pyrenetetracarboxylic acid.

In addition, a polyhydric alcohol other than isosorbide may be contained as required. Examples of the polyhydric alcohol include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, isosorbide, trimethylolethane, trimethylolpropane, 1,3,5-trihydroxymethylbenzene, bisphenol A, a bisphenol A ethylene oxide adduct, a bisphenol A propylene oxide adduct, hydrogenated bisphenol A, a hydrogenated bisphenol A ethylene oxide adduct, and a hydrogenated bisphenol A propylene oxide adduct.

It is preferred that the binder resin according to the present invention have low absorption of UV light. As a method of reducing the absorption of UV light, there is given a method involving reducing the amount of a unit having an aromatic ring in the binder resin.

Examples of the unit having an aromatic ring include styrene and the derivatives of styrene as given in the above-mentioned examples of the monomers, phthalic acid and the derivatives as given in the above-mentioned examples, and bisphenol A and various adducts of bisphenol A. The content of those units having aromatic rings is preferably 10.0 mass% or less, more preferably 5.0 mass% or less with respect to the binder resin.

Next, the toner of the present invention is described in detail.

The toner of the present invention is a toner including a toner particle containing a fluorescent agent that is excited with light at a wavelength of 400 nm or less, a binder resin, and a release agent, wherein, when an integral value of an emission intensity at 400 nm or more and 700 nm or less of an emission spectrum of the fluorescent agent for excitation light at a wavelength of 250 nm or more and 290 nm or less is represented by F3, an integral value of an emission intensity at 400 nm or more and 700 nm or less of an emission spectrum of the toner for excitation light at a wavelength of 250 nm or more and 290 nm or less is represented by F4, and a mass ratio of the fluorescent agent in the toner particle is represented by W2 (mass%), the following formulae (7) and (8) are satisfied.

$$\text{F4} \times \text{100/W2} \geq \text{F3} \times \text{0} \text{.30}$$

$$5.0 \leq \text{W2} \leq \text{80} \text{.0}$$

For the same reason as that stated in the description of the pigment dispersion above, it is conceived that the visibility at the time of irradiation with UV light can be increased. It is more preferred that the W2 satisfy the following formula (9).

$$30.0 \leq \text{W2} \leq \text{70} \text{.0}$$

It is preferred that a maximum value (Rmax2) of a light absorptivity in the wavelength range of 400 nm or more and 700 nm or less in an image obtained by forming the toner of the present invention on a medium at a laid-on level of 0.3 mg/cm² be 10% or less. For the same reason as that stated in the description of the pigment dispersion above, the invisibility is easily improved.

It is preferred that, when color coordinates obtained by transforming emission wavelength spectra of the toner of the present invention at the time of irradiation with excitation light at a wavelength of from 250 nm to 290 nm and a wavelength of from 315 nm to 400 nm into an L*a*b* color system are represented by G3 and G4, respectively, a difference ΔE2 between the color coordinates G3 and G4 be 20.0 or more. When the ΔE2 is 20.0 or more, two-color emission by two wavelengths is easily recognized, and the security can be improved. The range of the ΔE2 is more preferably 30.0 or more.

The toner of the present invention may be produced by a conventionally known method. There may be used, for example: a suspension polymerization method involving suspending and granulating a polymerizable monomer composition containing a polymerizable monomer for obtaining a binder resin, a fluorescent agent, and a release agent in an aqueous medium, and polymerizing the polymerizable monomer in the polymerizable monomer composition; a kneading pulverization method involving the steps of: melting and kneading various toner constituent materials containing a binder resin, a fluorescent agent, and a release agent to provide a kneaded product; pulverizing the kneaded product; and classifying the resultant; an emulsion aggregation method involving mixing a composition containing a binder resin, a dispersion liquid in which a fluorescent agent is emulsified and dispersed, and a dispersion liquid of a release agent, and aggregating and heat-fusing the mixture to provide toner particles; an emulsion polymerization aggregation method involving mixing a composition containing a dispersion liquid formed by subjecting a polymerizable monomer forming a binder resin to emulsion polymerization, a dispersion liquid in which a fluorescent agent is emulsified and dispersed, and a dispersion liquid of a release agent, and aggregating and heat-fusing the mixture to provide toner particles; and a dissolution suspension method involving suspending and granulating, in an aqueous medium, an organic solvent dispersion liquid containing a binder resin, a fluorescent agent, and a release agent in an organic solvent; and the like.

In the binder resin, it is preferred that a tetrahydrofuran (THF) insoluble content be 20 mass% or less and that an integral value of an absorption intensity at 250 nm or more and 290 nm or less (AInt 250 nm-290 nm) of a THF soluble content solution be 20 or less in UV-visible light absorption spectrum measurement (UV-vis). When the THF insoluble content of the binder resin is 20.0 mass% or less with respect to the total mass of the binder resin, and the absorption intensity of the THF soluble content is 20 or less, the visibility at the time of irradiation with UV light is easily improved.

In the present invention, an external additive may be externally added to the toner particles in order to improve toner image quality. As the external additive, inorganic fine powder, such as silica fine powder, titanium oxide fine powder, or aluminum oxide fine powder, may be used. The addition amount of the inorganic fine powder is preferably 0.5 mass% or more and 5.0 mass% or less based on the mass of the toner.

The toner of the present invention has a feature of containing a release agent. Examples of the release agent that may be used include an aliphatic hydrocarbon-based wax, an oxide of an aliphatic hydrocarbon-based wax, a block copolymer of an aliphatic hydrocarbon-based wax, a wax containing a fatty acid ester as a main component, a fatty acid ester that is partially or entirely deoxidized, such as a deoxidized carnauba wax, a partially esterified product of a fatty acid and a polyhydric alcohol, a methyl ester compound having a hydroxyl group obtained by hydrogenating a vegetable oil and fat, and Fischer-Tropsch wax. The content of the release agent in the toner particles is preferably 1.50 mass% or more and 20.0 mass% or less based on the mass of the toner.

A method of measuring each of physical properties of a pigment dispersion and a toner is described below.

### Method of Measuring Emission Spectrum and Method of Calculating F1 to F4

When a pigment dispersion contained water and an organic solvent, a solid content sample obtained when the pigment dispersion was heated at 130° C. until a change in mass of the pigment dispersion reached 0.3%/min or less was collected and filled into a quartz glass cell.

A fluorescent agent and a toner were each directly filled into a quartz glass cell. The prepared samples were measured with the following device under the following conditions.
Measurement device: Quantaurus-τ (manufactured by Hamamatsu Photonics, K.K.)
Excitation wavelength: 280 nm
Fluorescence wavelength: 400 nm to 700 nm
Step width: 2 nm
Integration: twice
Repetition frequency: 10 MHz

F1 to F4 were calculated from the measured spectra.

### Method of Measuring Rmax1 and Rmax2

A4 paper “High White Paper GF-C081” (manufactured by Canon Inc.) was used as a recording material, and a rectangular unfixed image of 1 cm×10 cm was formed on the paper so that the toner laid-on level was 0.30 mg/cm². The unfixed image was allowed to stand still in a natural convection constant-temperature dryer set to 110° C. for 3 minutes to fix the toner to the paper, to thereby provide a sample image (fixed image).

The above-mentioned sample image was subjected to spectroscopic analysis measurement in a wavelength range of 400 nm or more and 700 nm or less through use of a photometer described below, and a maximum value (Rmax2) of a light absorptivity in a wavelength range of 400 nm or more and 700 nm or less in the toner was calculated.

A UV-VIS-NIR spectrophotometer “UV-3600” (manufactured by Shimadzu Corporation) having an integrating sphere attachment device “ISR-240A” (manufactured by Shimadzu Corporation) attached thereto was used.

As a blank, paper alone (paper having no image formed thereon) is also subjected to spectroscopic analysis measurement. A value obtained by subtracting the measured value (light absorptivity (%)) of the paper alone from the measured value (light absorptivity (%)) of the sample image is defined as a light absorptivity (%) for evaluating the toner in the present invention. When the toner laid-on level of the unfixed image formed on the paper was not exactly 0.30 mg/cm², the absorptivity was calculated as described below.

An unfixed image having a toner laid-on level in a range of from 0.27 mg/cm² to 0.30 mg/cm² was formed and fixed to paper by the above-mentioned method to provide a first sample image. In addition, an unfixed image having a toner laid-on level in a range of from 0.30 mg/cm² to 0.33 mg/cm² was formed and fixed to paper by the above-mentioned method to provide a second sample image. Then, the first sample image and the second sample image were each subjected to spectroscopic analysis measurement.

A value obtained by subtracting the measured value (light absorptivity (%)) of the paper alone from the measured value (light absorptivity (%)) of the first sample image was defined as a first light absorptivity (%).

Similarly, a value obtained by subtracting the measured value (light absorptivity (%)) of the paper alone from the measured value (light absorptivity (%)) of the second sample image was defined as a second light absorptivity (%).

The first light absorptivity (%) and the second light absorptivity (%) were plotted on an x-y plane having the toner laid-on level as a horizontal axis and the light absorptivity as a vertical axis. Then, those two points were connected by a straight line, and a value corresponding to 0.30 mg/cm² was defined as a light absorptivity of the image having a toner laid-on level of 0.30 mg/cm².

Regarding a pigment dispersion, the pigment dispersion was applied to a lower half of super art paper with respect to a longitudinal direction through use of a wire bar. In this case, the model number of the wire bar was adjusted so that the toner laid-on level after drying became 0.30 mg/cm². The resultant image was subjected to spectroscopic analysis in the same manner as in the above-mentioned evaluation of the toner, and a light absorptivity was determined from the image having a toner laid-on level of 0.30 mg/cm². Then, a maximum value (Rmax1) of the light absorptivity in a wavelength range of 400 nm or more and 700 nm or less in a pigment was obtained.

### Method of Calculating ΔE1 and AE2

Spectra of a pigment dispersion or a toner were acquired in the same manner as in the above-mentioned method of measuring an emission spectrum except that the excitation wavelength was changed to 365 nm and the step width was changed to 10 nm, and each of the emission spectra thus acquired was transformed into an L*a*b* coordinate system in accordance with CIE1976. The ΔE1 regarding the pigment dispersion and the ΔE2 regarding the toner were calculated from the respective resultant L*a*b* coordinate systems.

### Method of Calculating Average Particle Diameter of Fluorescent Agent in Pigment Dispersion or Toner

When a pigment dispersion contained water and an organic solvent, a solid content sample was collected by the same method as the above-mentioned method of measuring an emission spectrum.

A cross-section of the solid content sample or the toner particles was produced through use of a cross-section polisher (product name: SM-09010) manufactured by JEOL Ltd. As a specific method, a section of a carbon double-sided pressure-sensitive adhesive sheet was bonded to a silicon wafer, and a Mo mesh (diameter: 3 mm/thickness: 30 µm) was fixed thereto. Then, the solid content sample or the toner particles were caused to adhere to the Mo mesh. After vapor deposition of platinum on the resultant, a cross-section of the solid content sample or the toner particles was formed through use of the cross-section polisher under the conditions of an acceleration voltage of 4 kV and a processing time of 3 hours. The resultant cross-section of the solid content sample or the toner particles was observed with a scanning electron microscope (SEM) (“S-4800” (manufactured by Hitachi High-Technologies Corporation)). The observation conditions were adjusted to the most visible conditions depending on the sample.

Images of five fields of view were measured at a magnification of 30.0 K, and the lengths of long sides of all the particles were measured.

From the data, the frequency was calculated in each data block (10 nm interval), and a cumulative distribution was created to calculate a 50% particle diameter on a number basis.

### Method of Measuring Weight Average Particle Diameter (D4) of Toner Particles and Toner

The weight average particle diameter (D4) of toner particles and a toner was measured with a precise particle size distribution measuring device “Coulter Counter Multisizer 3” (trademark, manufactured by Beckman Coulter, Inc.). The measurement was performed under the following conditions.
Number of effective measurement channels: 25,000 channels
Total number of control motors: 50,000
Aperture: 100 µm
Current: 1,600 µA
Gain: 2

A Kd value was measured with a value obtained through use of “standard particles of 10.0 µm” (manufactured by Beckman Coulter, Inc.). The weight average particle diameter (D4) was calculated by analyzing the measurement data with the dedicated software included in the device. The weight average particle diameter (D4) was an “average diameter” on an “Analysis/Volume Statistic Value (Arithmetic Average)” screen when Graph/Volume% was set in the above-mentioned dedicated software.

### Method of Measuring Amount of THF Insoluble Content of Binder Resin

1 g of a binder resin was precisely weighed and placed on cylindrical filter paper, and was subjected to Soxhlet extraction with 200 ml of tetrahydrofuran (THF) for 20 hours. After that, the cylindrical filter paper was taken out and dried in a vacuum at 40° C. for 20 hours. Then, the mass of the residue was measured, and the amount of the tetrahydrofuran (THF) insoluble content of the binder resin was calculated by the following formula.

Amount of THF insoluble content=Mass of residue/mass of binder resin before Soxhlet extraction×100 (mass%)

### Contents of Units of Formulae (4) to (6) in Binder Resin

The binder resin was separated by a solvent gradient elution method described below.

In the solvent gradient elution method, gradient preparative HPLC (LC-20AP high-pressure gradient preparative system manufactured by Shimadzu Corporation, SunFire preparative column 50 mm φ250 mm manufactured by Waters) is used. The column temperature is 30° C., and the flow rate is 50 mL/min. In a mobile phase, acetonitrile is used as a poor solvent, and THF is used as a good solvent.

In the same manner as in the above-mentioned measurement of the amount of an insoluble content, 0.02 g of the THF soluble content obtained by extraction dissolved in 1.5 mL of THF is used as a sample for separation. The mobile phase is started with the composition of 100% acetonitrile, and after an elapse of 5 minutes from the injection of the sample, the ratio of the THF is increased by 4% per minute to set the composition of the mobile phase to 100% THF over 25 minutes. The components can be separated by drying the resultant fractions to solidify. Thus, the components of the binder resin were separated.

The separated components may be identified by performing ¹H-NMR and ¹³C-NMR measurements as described in the following conditions.

(Measurement Conditions for Nuclear Magnetic Resonance Spectroscopy (¹H-NMR))
Measurement apparatus: FT NMR apparatus JNM-EX400 (manufactured by JEOL Ltd.)
Measurement frequency: 400 MHz
Pulse condition: 5.0 µs
Frequency range: 10,500 Hz
Number of scans: 64 times
Solvent: A deuterated solvent that dissolves a resin is appropriately used.

(Measurement Conditions for Solid-state ¹³C-NMR)
Apparatus: JNM-ECX500II manufactured by JEOL RESONANCE
Sample tube: 3.2 mmφ
Sample amount: 150 mg
Measurement temperature: room temperature
Pulse mode: CP/MAS
Measurement core frequency: 123.25 MHz (¹³C)
Reference substance: adamantane (external standard: 29.5 ppm)
Number of revolutions of sample: 20 kHz
Contact time: 2 ms
Delay time: 2 s
Number of scans: 1,024 times
Solvent: A deuterated solvent that dissolves a resin is appropriately used.

(Measurement Conditions for Pyrolysis-GCMS)
Measurement apparatus: pyrolysis-GCMS apparatus
Pyrolysis apparatus Curie Point Pyrolyzer JPS-700 (manufactured by Japan Analytical Industry)
Pyrofoil: F590 (Curie Point: 590° C.)
GCMS Focus GC/ISQ (manufactured by Thermo Fisher Scientific)
Carrier gas: He gas (purity: 99.99995%)
Column: HP-5MS (30 m, inner diameter: 0.25 mm, film thickness: 0.25 µm)
Injection port temperature: 280° C., MS transfer temperature: 280° C., ion source temperature: 250° C.
Oven temperature: An oven is started at 50° C. and held for 3 minutes, and then increased in temperature to 300° C. at 10° C./min and held for 30 minutes.
Helium flow rate: 1.2 mL/min constant flow rate control, split ratio: 20
MS ion source: EI, MS detection range (m/z) of from 25 to 800
Library: NIST

Under the above-mentioned measurement conditions, 0.5 mg of a resin and 5 µL of a methylation reagent (10% methanol solution of tetramethylammonium hydroxide) are added to Pyrofoil and analyzed.

### UV Absorption Measurement Method for Tetrahydrofuran (THF) Soluble Content

The THF soluble content extracted by the above-mentioned method of measuring an amount of a THF insoluble content of a binder resin was dried to solidify to provide a solid THF soluble content. 0.05 g of the resultant soluble content was dissolved in 2 g of THF and placed in a quartz cell. UV absorption measurement was performed with the following apparatus under the following conditions.
Measurement apparatus: UV-3100PC (manufactured by Shimadzu Corporation)
Slit width: 5.0 mm
Scan speed: low speed
Sampling pitch: 1 nm
Scan wavelength: 250 nm to 400 nm

An integral value of absorbance in a range of 250 nm or more and 290 nm of less of the resultant spectra was calculated.

### EXAMPLES

The present invention is specifically described below by way of Examples. However, the present invention is not limited to these Examples. All of “part(s)” of materials in Examples and Comparative Examples are by mass, unless otherwise stated.

### Production Example of Fluorescent Agent 1

Materials were placed in a glass container (manufactured by Tokyo Garasu Kikai Co., Ltd.) at mixing ratios described below and dispersed with a disperser (Disperser DAS H 200-K manufactured by LAU) for 10 hours.

| | |
|---|---|
| Fluobright⁺ Red/Blue Type (manufactured by Canon Optron, Inc.) | 5 parts by mass |
| RO water | 50 parts by mass |
| Glass beads (φ0.991 mm to φ1.397 mm) | 30 parts by mass |

After the dispersion, the glass beads were filtered with a mesh, and a fluorescent agent dispersion liquid was separated with a centrifuge to collect a precipitate. After that, the collected precipitate was dried in a vacuum. The resultant fluorescent agent 1 was calculated for the F1 by emission spectrum measurement.

### Production Examples of Fluorescent Agents 2 to 6

Fluorescent agents 2 to 6 were each produced in the same manner as in the production example of the fluorescent agent 1 except that the materials and the dispersion time were changed as shown in Table 1. Each of the resultant fluorescent agents was calculated for the F1 by emission spectrum measurement.

TABLE 1

| Fluorescent agent No. | Fluorescent material | Dispersion medium | Dispersion time (hr) | Bead diameter (mm) |
|---|---|---|---|---|
| 1 | FLUOBRIGHT⁺ Red/Blue Type | RO water | 10 | 0.991 to 1.397 |
| 2 | FLUOBRIGHT⁺ Red/Blue Type | RO water | 6 | 1.500 to 2.500 |
| 3 | FLUOBRIGHT⁺ Red/Blue Type | RO water | 3 | 1.500 to 2.500 |
| 4 | Tris(dibenzoylacetonato)-mono(fenanthroline)-europium(III) | Ethyl acetate | 5 | 0.991 to 1.397 |
| 5 | FLUOBRIGHT⁺ Red/Blue Type | Toluene | 5 | 1.500 to 2.500 |
| 6 | FLUOBRIGHT Blue Type | RO water | 10 | 0.991 to 1.397 |

Production Example of Resin P1

| | |
|---|---|
| Behenyl acrylate | 80.0 parts by mass |
| Methacrylonitrile | 19.0 parts by mass |
| Styrene | 1.0 part by mass |
| Toluene | 50.0 parts by mass |

The above-mentioned materials were mixed and heated to 70° C. After that, 1.0 part by mass of t-butyl peroxypivalate was added as a polymerization initiator to the mixture with stirring. Then, the temperature was kept at 70° C. and polymerization was performed for 5 hours. The temperature was further increased to 85° C., and the resultant was held by heating for 2 hours. After cooling, the resultant was reprecipitated in methanol, filtered, and dried to provide a resin P1.

### Production Examples of Resin P2, Resins P4 to P7, and Resin P10

A resin P2, resins P4 to P7, and a resin P10 were produced in the same manner as in the production example of the resin P1 except that the kinds and amounts of monomers were changed as shown in Table 2.

TABLE 2

| Resin P | Monomer 1 | | Monomer 2 | | Monomer 3 | |
|---|---|---|---|---|---|---|
| | Kind | Number of parts (part(s) by mass) | Kind | Number of parts (part(s) by mass) | Kind | Number of parts (part(s) by mass) |
| Resin P1 | BEA | 80.0 | St | 1.0 | MAN | 19.0 |
| Resin P2 | BEA | 65.0 | St | 25.0 | MAN | 10.0 |
| Resin P4 | BEA | 75.0 | St | 10.0 | MAN | 15.0 |
| Resin P5 | MMA | 100.0 | - | - | - | - |
| Resin P6 | tBA | 100.0 | - | - | - | - |
| Resin P7 | tBA | 95.0 | St | 5.0 | - | - |
| Resin P10 | St | 80.0 | nBA | 20.0 | - | - |

In Table 2, BEA represents n-behenyl acrylate, St represents styrene, MAN represents methacrylonitrile, MMA represents methyl methacrylate, tBA represents tert-butyl acrylate, and nBA represents n-butyl acrylate.

### Resin P3

Polylactic acid (10361D) manufactured by NatureWorks, LLC was used as a resin P3.

Production Example of Resin P8

| | |
|---|---|
| Terephthalic acid | 29.9 parts by mass |
| Bisphenol A-propylene oxide 2 mol adduct | 40.0 parts by mass |
| Isosorbide | 10.0 parts by mass |
| Ethylene glycol | 4.5 parts by mass |
| Tetrabutoxy titanate | 0.125 part by mass |

The above-mentioned monomers and catalyst were loaded into an autoclave with a pressure reduction device, a water separation device, a nitrogen gas introduction device, a temperature measurement device, and a stirring device, and the mixture was subjected to a reaction at 200° C. and normal pressure under a nitrogen atmosphere for 5 hours to provide a resin P8.

### Production Example of Resin P9

A resin P9 was produced in the same manner as in the production example of the resin P8 except that the monomers and catalyst were changed as described below.

| | |
|---|---|
| Bisphenol A-propylene oxide 2 mol adduct | 71.3 parts by mass |
| Terephthalic acid | 14.0 parts by mass |
| Isophthalic acid | 14.0 parts by mass |
| Tetrabutoxy titanate | 0.1 part by mass |
| Trimellitic acid | 0.90 part by mass |

Production Example of Pigment Dispersion 1

| | |
|---|---|
| Resin P1 | 40.0 parts by mass |
| Fluorescent agent 1 | 60.0 parts by mass |

The above-mentioned raw materials were loaded into a kneader-type mixer, and the temperature was increased under non-pressure with mixing. Further, the mixture was melted and kneaded by heating at from 90° C. to 100° C. for 15 minutes. After that, 100 parts by mass of toluene was added to the resultant, and the mixture was kneaded at 60° C. for 1 hour to provide a pigment dispersion 1. The resultant pigment dispersion 1 was measured for fluorescence spectra of a solid content sample obtained when the pigment dispersion 1 was heated at 130° C. until a change in mass of the pigment dispersion 1 reached 0.3%/min or less and calculated for the F2.

When the resultant fluorescence spectra were transformed into L*a*b* color coordinates, L*=4.8, a*=40.5, and b*=-58.5 were obtained in excitation at 365 nm, and L*=16.9, a*=34.6, and b*=-19.9 were obtained in excitation at 280 nm. From those values, the ΔE1 was calculated to be 40.8. The 50% particle diameter on a number distribution basis of the resultant solid content sample was measured from an SEM image of a cross-section to be 160 nm. The physical properties of the resultant pigment dispersion 1 are shown in Table 4.

### Production Examples of Pigment Dispersions 2 to 17 and Pigment Dispersions 1 to 4 for Comparison

Pigment dispersions 2 to 17 and pigment dispersions 1 to 4 for comparison were each produced in the same manner as in the production example of the pigment dispersion 1 except that the fluorescent agent and the binder resin were changed as shown in Table 3. The physical properties of the resultant pigment dispersions 2 to 17 and pigment dispersions 1 to 4 for comparison are shown in Table 4.

### Production Example of Pigment Dispersion 5 for Comparison

90.0 Parts by mass of the resin P1, 10.0 parts by mass of diethyl 2,5-dihydroxyterephthalate, and 100 parts by mass of toluene were dissolved at 80° C. to provide a pigment dispersion 5 for comparison. The physical properties of the resultant pigment dispersion 5 for comparison are shown in Table 4.

TABLE 3

| Pigment dispersion | Fluorescent agent | | Binder resin | | | | Solvent | |
|---|---|---|---|---|---|---|---|---|
| No. | No. | Number of parts (part(s) by mass) | No. | Number of parts (part(s) by mass) | No. | Number of parts (part(s) by mass) | Kind | Number of parts (part(s) by mass) |
| 1 | Fluorescent agent 1 | 60.0 | Resin P1 | 40.0 | - | - | Toluene | 50.0 |
| 2 | Fluorescent agent 1 | 5.0 | Resin P1 | 95.0 | - | - | Toluene | 100.0 |
| 3 | Fluorescent agent 2 | 80.0 | Resin P1 | 20.0 | - | - | Toluene | 50.0 |
| 4 | Fluorescent agent 1 | 60.0 | Resin P2 | 40.0 | - | - | Toluene | 50.0 |
| 5 | Fluorescent agent 3 | 80.0 | Resin P1 | 20.0 | - | - | Toluene | 50.0 |
| 6 | Fluorescent agent 4 | 10.0 | Resin P3 | 90.0 | - | - | Toluene | 100.0 |
| 7 | Fluorescent agent 5 | 50.0 | Resin P3 | 50.0 | - | - | Toluene | 60.0 |
| 8 | Fluorescent agent 1 | 30.0 | Resin P3 | 70.0 | - | - | Toluene | 100.0 |
| 9 | Fluorescent agent 1 | 70.0 | Resin P3 | 30.0 | - | - | Toluene | 50.0 |
| 10 | Fluorescent agent 1 | 20.0 | Resin P3 | 80.0 | - | - | Toluene | 100.0 |
| 11 | Fluorescent agent 1 | 60.0 | Resin P4 | 40.0 | | - | Toluene | 50.0 |
| 12 | Fluorescent agent 2 | 60.0 | Resin P3 | 40.0 | - | - | Toluene | 50.0 |
| 13 | Fluorescent agent 1 | 60.0 | Resin P5 | 40.0 | - | - | Toluene | 50.0 |
| 14 | Fluorescent agent 1 | 60.0 | Resin P6 | 40.0 | - | - | Toluene | 50.0 |
| 15 | Fluorescent agent 1 | 60.0 | Resin P7 | 40.0 | - | - | Toluene | 50.0 |
| 16 | Fluorescent agent 1 | 60.0 | Resin P3 | 28.0 | Resin P8 | 12.0 | Toluene | 50.0 |
| 17 | Fluorescent agent 6 | 60.0 | Resin P1 | 40.0 | - | - | Toluene | 50.0 |
| 1 for comparison | - | - | Resin P1 | 100.0 | - | - | Toluene | 100.0 |
| 2 for comparison | Fluorescent agent 1 | 60.0 | Resin P9 | 40.0 | - | - | Toluene | 50.0 |
| 3 for comparison | Fluorescent agent 1 | 60.0 | Resin P10 | 40.0 | - | - | Toluene | 50.0 |
| 4 for comparison | Fluorescent agent 2 | 90.0 | Resin P1 | 10.0 | - | - | Toluene | 50.0 |
| 5 for comparison | Diethyl 2,5-dihydroxyterephth alate | 10.0 | Resin P1 | 90.0 | - | - | Toluene | 100.0 |

TABLE 4

| Pigment dispersion No. | F1 | F2 | W1 (mass%) | (F2×100/W1)-(F1×0.30) | 50% particle diameter (nm) | ΔE1 | Rmax1 | Contents of formulae (4) to (6) (mass%) |
|---|---|---|---|---|---|---|---|---|
| 1 | 4.09×10⁵ | 2.69×10⁵ | 60.0 | 3.26×10⁵ | 160 | 40.8 | 5 | 99 |
| 2 | 4.09×10⁵ | 1.80×10⁴ | 5.0 | 2.37×10⁵ | 150 | 37.3 | 4.5 | 99 |
| 3 | 4.09×10⁵ | 3.37×10⁵ | 80.0 | 2.98×10⁵ | 350 | 40.1 | 9.7 | 99 |
| 4 | 4.09×10⁵ | 8.97×10⁵ | 60.0 | 2.67×10⁴ | 170 | 40.8 | 5.5 | 75 |
| 5 | 4.09×10⁵ | 2.34×10⁵ | 80.0 | 1.70×10⁵ | 480 | 36.3 | 12 | 99 |
| 6 | 3.18×10⁶ | 2.30×10⁶ | 30.0 | 6.73×10⁶ | 200 | 9.2 | 6 | 100 |
| 7 | 4.09×10⁵ | 1.95×10⁵ | 60.0 | 2.01×10⁵ | 570 | 40.8 | 15 | 100 |
| 8 | 4.09×10⁵ | 1.57×10⁵ | 30.0 | 4.01×10⁵ | 150 | 40.5 | 4 | 100 |
| 9 | 4.09×10⁵ | 3.23×10⁵ | 70.0 | 3.39×10⁵ | 160 | 40.3 | 7 | 100 |
| 10 | 4.09×10⁵ | 5.38×10⁴ | 20.0 | 1.46×10⁵ | 150 | 39.4 | 3 | 100 |
| 11 | 4.09×10⁵ | 1.35×10⁵ | 60.0 | 1.02×10⁵ | 160 | 35.6 | 6.5 | 90 |
| 12 | 4.09×10⁵ | 2.96×10⁵ | 60.0 | 3.71×10⁵ | 310 | 38.2 | 6.5 | 100 |
| 13 | 4.09×10⁵ | 2.84×10⁵ | 60.0 | 3.51×10⁵ | 170 | 39.4 | 5 | 100 |
| 14 | 4.09×10⁵ | 2.80×10⁵ | 60.0 | 3.44×10⁵ | 160 | 39.6 | 4.5 | 100 |
| 15 | 4.09×10⁵ | 2.05×10⁵ | 60.0 | 2.19×10⁵ | 160 | 40.3 | 4.5 | 95 |
| 16 | 4.09×10⁵ | 2.68×10⁵ | 60.0 | 3.23×10⁵ | 160 | 40.5 | 5 | 91 |
| 17 | 3.95×10⁵ | 3.21×10⁵ | 60.0 | 4.17×10⁵ | 200 | 9.3 | 5.5 | 99 |
| 1 for comparison | - | - | 0.0 | - | - | 5.3 | 2 | 99 |
| 2 for comparison | 4.09×10⁵ | 4.53×10⁴ | 60.0 | -4.73×10⁴ | 150 | 9.1 | 4.6 | 0 |
| 3 for comparison | 4.09×10⁵ | 3.70×10⁴ | 60.0 | -6.11×10⁴ | 150 | 7.2 | 4.6 | 0 |
| 4 for comparison | 4.09×10⁵ | 3.65×10⁵ | 90.0 | 2.83×10⁵ | 400 | 39.1 | 20 | 99 |
| 5 for comparison | 2.53×10⁶ | 1.45×10⁶ | 10.0 | 1.37×10⁷ | - | 12.1 | 3.5 | 99 |

Production Example of toner particles 1

| | |
|---|---|
| Fluorescent agent 1 | 60.0 parts by mass |
| Resin P1 | 34.5 parts by mass |
| Paraffin wax (DSC endothermic peak temperature: 80° C.) | 4.0 parts by mass |

The raw materials described in the formulation above were mixed with a Henschel mixer (Model FM-75, manufactured by Mitsui Mining Co., Ltd.) at a rotation speed of 20 s⁻¹ for a rotation time of 5 min. After that, the mixture was kneaded in a twinscrew kneader (Model PCM-30, manufactured by Ikegai Ironworks Corp.) set to a temperature of 125° C. The resultant kneaded product was cooled and coarsely pulverized to 1 mm or less with a hammer mill to provide a coarsely pulverized product. The resultant coarsely pulverized product was finely pulverized with a mechanical pulverizer (T-250, manufactured by Turbo Kogyo Co., Ltd.). Further, the resultant was classified through use of a rotary classifier (200TSP, manufactured by Hosokawa Micron Corporation) to provide toner particles 1.

### Production Examples of Toner Particles 2 to 17 and Toners 1 to 4 for Comparison

Toner particles 2 to 17 and toners 1 to 4 for comparison were obtained in the same manner as in the production example of the toner particles 1 except that the materials were changed as shown in Table 5.

TABLE 5

| Toner particles | Fluorescent agent | | Binder resin | | | | Release agent |
|---|---|---|---|---|---|---|---|
| No. | No. | Number of parts (part(s) by mass) | No. | Number of parts (part(s) by mass) | No. | Number of parts (part(s) by mass) | Number of parts (part(s) by mass) |
| 1 | Fluorescent agent 1 | 60.0 | Resin P1 | 34.5 | - | - | 4.0 |
| 2 | Fluorescent agent 1 | 5.0 | Resin P1 | 86.5 | - | - | 7.0 |
| 3 | Fluorescent agent 2 | 80.0 | Resin P1 | 16.5 | - | - | 2.0 |
| 4 | Fluorescent agent 1 | 60.0 | Resin P2 | 34.5 | - | - | 4.0 |
| 5 | Fluorescent agent 3 | 80.0 | Resin P1 | 16.5 | - | - | 2.0 |
| 6 | Fluorescent agent 4 | 10.0 | Resin P3 | 81.5 | - | - | 7.0 |
| 7 | Fluorescent agent 5 | 50.0 | Resin P3 | 43.5 | - | - | 5.0 |
| 8 | Fluorescent agent 1 | 30.0 | Resin P3 | 62.5 | - | - | 6.0 |
| 9 | Fluorescent agent 1 | 70.0 | Resin P3 | 25.5 | - | - | 3.0 |
| 10 | Fluorescent agent 1 | 20.0 | Resin P3 | 70.5 | - | - | 8.0 |
| 11 | Fluorescent agent 1 | 60.0 | Resin P4 | 34.5 | - | - | 4.0 |
| 12 | Fluorescent agent 2 | 60.0 | Resin P3 | 34.5 | - | - | 4.0 |
| 13 | Fluorescent agent 1 | 60.0 | Resin P5 | 34.5 | - | - | 4.0 |
| 14 | Fluorescent agent 1 | 60.0 | Resin P6 | 34.5 | - | - | 4.0 |
| 15 | Fluorescent agent 1 | 60.0 | Resin P7 | 34.5 | - | - | 4.0 |
| 16 | Fluorescent agent 1 | 60.0 | Resin P3 | 22.5 | Resin P8 | 12.0 | 4.0 |
| 17 | Fluorescent agent 6 | 60.0 | Resin P1 | 34.5 | - | - | 4.0 |
| 1 for comparison | - | - | Resin P1 | 90.5 | - | - | 8.0 |
| 2 for comparison | Fluorescent agent 1 | 60.0 | Resin P9 | 34.5 | - | - | 4.0 |
| 3 for comparison | Fluorescent agent 1 | 60.0 | Resin P10 | 34.5 | - | - | 4.0 |
| 4 for comparison | Fluorescent agent 2 | 90.0 | Resin P1 | 5.50 | - | - | 3.0 |

Production Example of Toner Particles 5 for Comparison

| | |
|---|---|
| Diethyl 2,5-dihydroxyterephthalate | 10.0 parts by mass |
| Resin P1 | 79.5 parts by mass |
| Paraffin wax (DSC endothermic peak temperature: 80° C.) | 9.0 parts by mass |
| Toluene | 20.0 parts by mass |

The raw materials described in the formulation above were mixed with a Henschel mixer (Model FM-75, manufactured by Mitsui Mining Co., Ltd.) at a rotation speed of 20 s⁻¹ for a rotation time of 5 min. After that, the mixture was kneaded in a twinscrew kneader (Model PCM-30, manufactured by Ikegai Ironworks Corp.) set to a temperature of 80° C. After that, the resultant was increased in temperature to 140° C. and kneaded again. The resultant kneaded product was cooled and coarsely pulverized to 1 mm or less with a hammer mill to provide a coarsely pulverized product. The resultant coarsely pulverized product was finely pulverized with a mechanical pulverizer (T-250, manufactured by Turbo Kogyo Co., Ltd.). Further, the resultant was classified through use of a rotary classifier (200TSP, manufactured by Hosokawa Micron Corporation) to provide toner particles 5 for comparison.

### Production Example of Toner Particles 18

390.0 Parts by mass of ion-exchanged water and 14.0 parts by mass of sodium phosphate (dodecahydrate) were loaded into a reaction vessel, and the reaction vessel was kept at 65° C. for 1 hour with nitrogen purging. Next, a calcium chloride aqueous solution containing 9.2 parts by mass of calcium chloride (dihydrate) dissolved in 10.0 parts by mass of ion-exchanged water was loaded in one batch into the resultant with stirring at 12,000 rpm through use of a T.K. homomixer (manufactured by Tokushu Kika Kogyo Co., Ltd.), to thereby prepare an aqueous medium containing a dispersion stabilizer. Further, hydrochloric acid was loaded into the aqueous medium to adjust the pH to 6.0 to provide an aqueous medium 1.

Next, the following materials were mixed.

| | |
|---|---|
| Fluorescent agent 1 | 60.0 parts by mass |
| Behenyl acrylate | 27.6 parts by mass |
| Styrene | 0.34 part by mass |
| Methacrylonitrile | 6.56 parts by mass |
| Wax (Fischer-Tropsch wax, melting point: 78° C.) | 4.0 parts by mass |
| Resin P8 | 1.0 part by mass |

The mixture was kept at 65° C. and uniformly dissolved and dispersed at 500 rpm through use of the T.K. homomixer to prepare a polymerizable monomer composition 1.

While the temperature of the aqueous medium 1 was kept at 70° C. and the rotation speed of a stirring device was kept at 12,000 rpm, the polymerizable monomer composition 1 was loaded into the aqueous medium 1, and 9.0 parts by mass of t-butyl peroxypivalate was added as a polymerization initiator. While the rotation speed was maintained at 12,000 rpm in the stirring device, the resultant was granulated for 10 minutes.

The stirring device was changed to a stirrer with a propeller stirring blade, and the resultant was polymerized for 5 hours while being kept at 70° C. with stirring at 150 rpm. Further, the resultant was increased in temperature to 85° C. and kept by heating for 2 hours. After that, the resultant was cooled to room temperature to provide a toner particle dispersion liquid 18.

Hydrochloric acid was added to the resultant toner particle dispersion liquid 18 to adjust the pH to 1.4 or less, and the above-mentioned dispersion stabilizer was dissolved, followed by filtration, washing, and drying, to provide toner particles 18.

### Production Example of Toner 1

1.5 Parts of hydrophobic silica fine particles each having a BET value of 200 m²/g and having a number average particle diameter of primary particles of 8 nm were mixed with 98.5 parts by mass of the resultant toner particles 1 with a Henschel mixer (manufactured by Mitsui Mining Co., Ltd.) to provide a toner 1.

The resultant toner was measured for fluorescence spectra and calculated for the F4.

When the resultant fluorescence spectra were transformed into L*a*b* color coordinates, L*=4.7, a*=41.0, and b*=-58.5 were obtained in excitation at 365 nm, and L*=16.9, a*=34.6, and b*=-19.9 were obtained in excitation at 280 nm. From those values, the ΔE2 was calculated to be 40.9. The number average 50% particle diameter of the resultant solid content sample was measured from an SEM image of a cross-section to be 160 nm. The physical properties of the resultant toner 1 are shown in Table 6.

### Production Examples of Toners 2 to 18 and Toners 1 to 5 for Comparison

The resultant toner particles 2 to 18 and toner particles 1 to 5 for comparison were used to produce toners 2 to 18 and toners 1 to 5 for comparison, respectively, in the same manner as in the production example of the toner 1.

The physical properties of the resultant toners 2 to 18 and toners 1 to 5 for comparison are shown in Table 6.

TABLE 6

| Toner No. | F1 | F2 | W1 (mass%) | (F2×100/W1) -(F1×0.30) | Average particle diameter of fluorescent agent (nm) | ΔE2 | Rmax2 | Weight average particle diameter of toner (µm) | THF insoluble content (mass%) | Aint 250-290 | Contents of formulae (4) to (6) (mass%) |
|---|---|---|---|---|---|---|---|---|---|---|---|
| 1 | 4.09×10⁵ | 2.58×10⁵ | 60.0 | 3.08×10⁵ | 160 | 40.9 | 4.6 | 6.9 | 8.0 | 4 | 99 |
| 2 | 4.09×10⁵ | 1.57×10⁴ | 5.0 | 1.90×10⁵ | 150 | 41.4 | 4.7 | 7.1 | 7.0 | 6 | 99 |
| 3 | 4.09×10⁵ | 3.26×10⁵ | 80.0 | 2.85×10⁵ | 350 | 42.4 | 9.8 | 6.8 | 6.0 | 5 | 99 |
| 4 | 4.09×10⁵ | 9.06×10⁵ | 20.0 | 3.30×10⁵ | 170 | 41.9 | 5.5 | 7.7 | 15.0 | 17 | 75 |
| 5 | 4.09×10⁵ | 2.08×10⁵ | 80.0 | 1.38×10⁵ | 480 | 41.6 | 12.5 | 6.7 | 3.0 | 4 | 99 |
| 6 | 3.21×10⁶ | 2.15×10⁶ | 40.0 | 4.41×10⁶ | 200 | 9.9 | 6.1 | 7.3 | 6.0 | 5 | 100 |
| 7 | 4.09×10⁵ | 1.83×10⁵ | 60.0 | 1.82×10⁵ | 570 | 41.1 | 14 | 6.1 | 7.0 | 6 | 100 |
| 8 | 4.09×10⁵ | 1.48×10⁵ | 30.0 | 3.69×10⁵ | 150 | 41.9 | 4 | 6.2 | 6.0 | 5 | 100 |
| 9 | 4.09×10⁵ | 2.97×10⁵ | 70.0 | 3.02×10⁵ | 160 | 42.1 | 8 | 7.1 | 7.0 | 6 | 100 |
| 10 | 4.09×10⁵ | 4.58×10⁴ | 20.0 | 1.06×10⁵ | 150 | 41.6 | 2.9 | 6.6 | 6.0 | 6 | 100 |
| 11 | 4.09×10⁵ | 1.20×10⁵ | 60.0 | 7.69×10⁴ | 160 | 43.3 | 6.5 | 7.5 | 4.0 | 10 | 90 |
| 12 | 4.09×10⁵ | 2.84×10⁵ | 60.0 | 3.51×10⁵ | 160 | 41.1 | 6.4 | 6.3 | 5.0 | 6 | 100 |
| 13 | 4.09×10⁵ | 2.70×10⁵ | 60.0 | 3.27×10⁵ | 170 | 42.4 | 5.1 | 7.6 | 7.0 | 5 | 100 |
| 14 | 4.09×10⁵ | 2.63×10⁵ | 60.0 | 3.16×10⁵ | 160 | 42.1 | 4.6 | 6.5 | 9.0 | 4 | 100 |
| 15 | 4.09×10⁵ | 2.25×10⁵ | 60.0 | 2.52×10⁵ | 160 | 41.9 | 4.4 | 7.5 | 8.0 | 6 | 95 |
| 16 | 4.09×10⁵ | 2.46×10⁵ | 60.0 | 2.87×10⁵ | 160 | 42.6 | 5.1 | 7.7 | 7.0 | 5 | 91 |
| 17 | 3.95×10⁵ | 3.12×10⁵ | 60.0 | 4.01×10⁵ | 200 | 9.7 | 5.6 | 6.5 | 6.0 | 6 | 99 |
| 18 | 4.09×10⁵ | 2.06×10⁵ | 60.0 | 2.20×10⁵ | 300 | 41.6 | 5.8 | 6.1 | 16.0 | 5 | 99 |
| 1 for comparison | - | - | 0.0 | - | - | 5.6 | 1.9 | 6.1 | 8.0 | 4 | 99 |
| 2 for comparison | 4.09×10⁵ | 4.35×10⁴ | 60.0 | -5.03×10⁴ | 150 | 6.7 | 4.6 | 6.7 | 9.0 | 48 | 0 |
| 3 for comparison | 4.09×10⁵ | 3.44×10⁴ | 60.0 | -6.54×10⁴ | 150 | 7.5 | 4.5 | 7.5 | 8.0 | 50 | 0 |
| 4 for comparison | 4.09×10⁵ | 3.53×10⁵ | 90.0 | 2.69×10⁵ | 400 | 39.1 | 19.2 | 6.7 | 7.0 | 7 | 99 |
| 5 for comparison | 2.42×10⁶ | 1.65 ×10⁶ | 10.0 | 1.58×10⁷ | - | 12.4 | 3.4 | 7.6 | 8.0 | 14 | 99 |

### Examples 1 to 35

Evaluation was performed through use of the pigment dispersions 1 to 17 in Examples 1 to 17, respectively and through use of the toners 1 to 18 in Examples 18 to 35, respectively. The evaluation methods and results are described below. The evaluation results are shown in Table 7.

### Comparative Examples 1 to 10

Evaluation was performed through use of the pigment dispersions 1 to 5 for comparison in Comparative Examples 1 to 5, respectively and through use of the toners 1 to 5 for comparison in Comparative Examples 6 to 10, respectively. The evaluation was performed in the same manner as in Examples 1 to 35. The evaluation results are shown in Table 7.

### Evaluation of Visibility at Time of Irradiation With UV Light

For evaluation of a pigment dispersion, super art paper [SA Kinfuji Plus 180 kg manufactured by Oji Paper Co. Ltd.] cut into 80 mm×160 mm was used. The pigment dispersion was applied to a lower half of the super art paper with respect to a longitudinal direction through use of a wire bar so that an application portion and a non-application portion were formed in the same paper. At the time of application, the model number of the wire bar was adjusted so that the toner laid-on level after drying became 0.3 mg/cm². Two sheets of products were produced. After a coating film was dried, light in a wavelength range of from 250 nm to 290 nm was applied to each of the printed products through use of a UV irradiation device (ENF260-CJ).

A portion (image portion) in which the coating film was formed on the paper and a portion (non-image portion) in which the coating film was not formed thereon were visually compared to each other, and whether or not identification was able to be performed was ranked based on the following criteria.

A: The image portion can be identified even when the distance from the paper is 100 cm or more.

B: The image portion cannot be identified when the distance from the paper is 100 cm, but can be identified when checked at a distance of 30 cm.

C: The image portion cannot be identified when the distance from the paper is 30 cm, but can be identified when checked at a distance from the paper of 10 cm.

D: The image portion cannot be identified even when checked at a distance from the paper of 10 cm.

When a toner was evaluated, a color laser printer (HP Color LaserJet 3525dn, manufactured by Hewlett-Packard Company) was prepared and reconstructed so as to be capable of changing the laid-on level. A toner was removed from a cyan cartridge, and a toner to be evaluated was instead filled into the cyan cartridge. Next, the laid-on level was adjusted to 0.3 mg/cm² through use of the filled toner on a medium (GF-C081, basis weight: 81.4 g/m²), and a fixed image was output to the center of the paper in an image pattern having a square of 50 mm×50 mm. The output image was ranked in the same manner as in the evaluation of the pigment dispersion by comparing the image portion and the non-image portion to each other.

### Evaluation of Recognizability (Two-Color Recognizability) at Time of Two-Wavelength Irradiation

The same evaluation as the above-mentioned evaluation of visibility at the time of irradiation with UV light was performed also under irradiation with UV light at from 315 nm to 400 nm, and evaluation was visually performed under a state in which the image was placed at a distance of 100 cm.

A: Even when a UV wavelength is switched in the same image, the image can be recognized as two colors.

B: When images irradiated with light at respective wavelengths are arranged side by side, those images can be recognized as two colors.

C: When images irradiated with light at respective wavelengths are arranged side by side, a slight difference in color can be recognized.

D: A difference in color cannot be recognized.

### Evaluation of Invisibility

The same image formation as that in the evaluation of visibility at the time of irradiation with UV light was performed on a pigment dispersion and a toner.

In normal room light, the image portion and the non-image portion were compared to each other, and the identification based on the following criteria was performed.

A: The image portion cannot be identified when the distance from the paper is 10 cm.

B: The image portion can be identified when the distance from the paper is 10 cm, and cannot be identified when the distance from the paper is 30 cm.

C: The image portion can be identified when the distance from the paper is 30 cm, and cannot be identified when the distance from the paper is 100 cm.

D: The image portion can be identified even when the distance from the paper is 100 cm.

### Evaluation of Light Fastness

The same image formation as that in the above-mentioned evaluation of visibility was performed, and the L*a*b* color coordinates transformed from the spectra at the time of irradiation with UV light were defined as an initial value. After that, the image was irradiated with light at an intensity of 80,000 (lux) in a super fluorescent lamp fade meter FL (manufactured by Suga Test Instruments Co., Ltd.) for 180 hours under a normal-temperature and normal-humidity environment (23° C./60%RH). After that, the spectra at the time of irradiation with UV light were measured again and transformed into L*a*b* color coordinates to provide a difference in color (ΔE3) from the initial value. Ranking was performed based on the following criteria.

A: The ΔE3 is 3.0 or less.

B: The ΔE3 is more than 3.0 and 6.0 or less.

C: The ΔE3 is more than 6.0 and 9.0 or less.

D: The ΔE3 is more than 9.0.

TABLE 7

| Example | Corresponding pigment dispersion or toner | Visibility at time of irradiation with UV light | Invisibility | Two-color recognizab ility | Light fastness | |
|---|---|---|---|---|---|---|
| | | | | | Rank | ΔE3 |
| Example 1 | Pigment dispersion 1 | A | A | A | A | 2 |
| Example 2 | Pigment dispersion 2 | C | A | C | A | 1.5 |
| Example 3 | Pigment dispersion 3 | A | C | A | B | 4.5 |
| Example 4 | Pigment dispersion 4 | C | A | C | A | 1.7 |
| Example 5 | Pigment dispersion 5 | A | C | A | B | 3.2 |
| Example 6 | Pigment dispersion 6 | A | B | C | C | 8.1 |
| Example 7 | Pigment dispersion 7 | B | C | A | B | 3.4 |
| Example 8 | Pigment dispersion 8 | A | A | B | B | 3.2 |
| Example 9 | Pigment dispersion 9 | A | B | A | B | 5 |
| Example 10 | Pigment dispersion 10 | B | A | B | B | 3.3 |
| Example 11 | Pigment dispersion 11 | B | A | B | A | 2.1 |
| Example 12 | Pigment dispersion 12 | A | B | A | B | 3.3 |
| Example 13 | Pigment dispersion 13 | A | A | A | B | 3.4 |
| Example 14 | Pigment dispersion 14 | A | A | A | B | 3.1 |
| Example 15 | Pigment dispersion 15 | B | A | A | B | 3 |
| Example 16 | Pigment dispersion 16 | B | A | A | B | 3.3 |
| Example 17 | Pigment dispersion 17 | A | A | C | A | 2.2 |
| Example 18 | Toner 1 | A | A | A | A | 2.5 |
| Example 19 | Toner 2 | C | A | C | A | 1.9 |
| Example 20 | Toner 3 | A | C | A | B | 4.8 |
| Example 21 | Toner 4 | C | A | C | A | 2.4 |
| Example 22 | Toner 5 | A | C | A | B | 3.6 |
| Example 23 | Toner 6 | A | B | C | C | 8.5 |
| Example 24 | Toner 7 | B | C | A | B | 3.7 |
| Example 25 | Toner 8 | A | A | B | B | 3.2 |
| Example 26 | Toner 9 | A | B | A | B | 5 |
| Example 27 | Toner 10 | B | A | B | B | 3.3 |
| Example 28 | Toner 11 | B | A | B | A | 2.5 |
| Example 29 | Toner 12 | A | A | A | B | 3.9 |
| Example 30 | Toner 13 | A | A | A | B | 3.9 |
| Example 31 | Toner 14 | A | A | A | B | 3.6 |
| Example 32 | Toner 15 | A | A | A | B | 3.3 |
| Example 33 | Toner 16 | B | A | A | B | 4.1 |
| Example 34 | Toner 17 | A | A | C | A | 2.7 |
| Example 35 | Toner 18 | B | A | A | A | 2.3 |
| Comparative Example 1 | Pigment dispersion 1 for comparison | D | A | D | A | 1.4 |
| Comparative Example 2 | Pigment dispersion 2 for comparison | D | A | D | A | 2.2 |
| Comparative Example 3 | Pigment dispersion 3 for comparison | D | A | D | A | 2.6 |
| Comparative Example 4 | Pigment dispersion 4 for comparison | A | D | A | A | 2.5 |
| Comparative Example 5 | Pigment dispersion 5 for comparison | A | A | C | D | 18 |
| Comparative Example 6 | Toner 1 for comparison | D | A | D | A | 1.2 |
| Comparative Example 7 | Toner 2 for comparison | D | A | D | A | 2.6 |
| Comparative Example 8 | Toner 3 for comparison | D | A | D | A | 2.3 |
| Comparative Example 9 | Toner 4 for comparison | A | D | A | A | 2.4 |
| Comparative Example 10 | Toner 5 for comparison | A | A | C | D | 17.2 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-197360, filed Dec. 3, 2021 which is hereby incorporated by reference herein in its entirety.

What is claimed is:

1. A pigment dispersion comprising a fluorescent agent and a binder resin,
wherein the fluorescent agent is excited with light at a wavelength of 400 nm or less,
wherein, when an integral value of an emission intensity in a wavelength range of 400 nm or more and 700 nm or less of an emission spectrum of the fluorescent agent for excitation light at a wavelength of 250 nm or more and 290 nm or less is represented by F1, an integral value of an emission intensity in a wavelength range of 400 nm or more and 700 nm or less of an emission spectrum of the pigment dispersion for excitation light at a wavelength of 250 nm or more and 290 nm or less is represented by F2, and a ratio of the fluorescent agent contained in a solid content obtained when the pigment dispersion is heated at 130° C. until a change in mass of the pigment dispersion reaches 0.3%/min or less is represented by W1 (mass%),
the F1, the F2, and the W1 satisfy the following formulae (1) and (2).
$$\text{F2} \times 100 / \text{W1} \geq \text{F1} \times \text{0} \text{.30}$$
$$5.0 \leq \text{W1} \leq \text{80} \text{.0}$$
.

2. The pigment dispersion according to claim 1, wherein a maximum value (Rmax1) of a light absorptivity in the wavelength range of 400 nm or more and 700 nm or less in an image of the solid content formed of the pigment dispersion on a medium at a laid-on level of 0.3 mg/cm² is 10% or less.

3. The pigment dispersion according to claim 1, wherein the fluorescent agent is an inorganic compound containing a lanthanoid element and containing calcium fluoride as a main component.

4. The pigment dispersion according to claim 1, wherein, in a sectional observation image of the solid content of the pigment dispersion with a scanning electron microscope (SEM), the fluorescent agent has a 50% particle diameter on a number basis of 500 nm or less.

5. The pigment dispersion according to claim 1, wherein the W1 (mass%) satisfies the following formula (3).
$$30.0 \leq \text{W1} \leq 7 \text{0} \text{.0}$$
.

6. The pigment dispersion according to claim 1, wherein the binder resin in the pigment dispersion contains one or more kinds of units selected from units each represented by any one of the following formulae (4) to (6), and a total content ratio of the units each represented by any one of the formulae (4) to (6) in a total mass of the binder resin is 70 mass% or more: 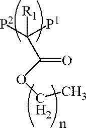
in the formula (4), P¹ and P² each represent a bonding site to a main chain skeleton of a resin, Ri represents a hydrogen atom or a methyl group, and “n” represents an integer of 0 or more and 30 or less; 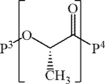
in the formula (5), P³ and P⁴ each represent a bonding site to the main chain skeleton of the resin; 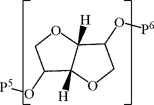
in the formula (6), P⁵ and P⁶ each represent a bonding site to the main chain skeleton of the resin.

7. The pigment dispersion according to claim 6,
wherein the binder resin in the pigment dispersion contains the unit represented by the formula (4), and
wherein the “n” in the formula (4) is 16 or more and 30 or less.

8. The pigment dispersion according to claim 1, wherein, when color coordinates obtained by transforming emission wavelength spectra of the pigment dispersion at a time of irradiation with excitation light at a wavelength of 250 nm or more and 290 nm or less and a wavelength of 315 nm or more and 400 nm or less into an L*a*b* color system are represented by G1 and G2, respectively, a difference ΔE1 between the color coordinates G1 and G2 is 20.0 or more.

9. A toner comprising a toner particle containing a fluorescent agent that is excited with light at a wavelength of 400 nm or less, a binder resin, and a release agent,
wherein, when an integral value of an emission intensity in a wavelength range of 400 nm or more and 700 nm or less of an emission spectrum of the fluorescent agent for excitation light at a wavelength of 250 nm or more and 290 nm or less is represented by F3, an integral value of an emission intensity in a wavelength range of 400 nm or more and 700 nm or less of an emission spectrum of the toner for excitation light at a wavelength of 250 nm or more and 290 nm or less is represented by F4, and a mass ratio of the fluorescent agent in the toner particle is represented by W2 (mass%), the following formulae (7) and (8) are satisfied.
$$\text{F4} \times 100 / \text{W2} \geq \text{F3} \times \text{0} \text{.30}$$
$$5.0 \leq \text{W2} \leq 8 \text{0} \text{.0}$$
.

10. The toner according to claim 9, wherein a maximum value (Rmax2) of a light absorptivity in the wavelength range of 400 nm or more and 700 nm or less in an image obtained by forming the toner on a medium at a laid-on level of 0.3 mg/cm² is 10% or less.

11. The toner according to claim 9, wherein the fluorescent agent is an inorganic compound containing a lanthanoid element and containing calcium fluoride as a main component.

12. The toner according to claim 9, wherein, in a sectional observation image of the toner particle with a scanning electron microscope (SEM), the toner particle has a 50% particle diameter on a number basis of 500 nm or less.

13. The toner according to claim 9, wherein the W2 satisfies the following formula (9).
$$30.0 \leq \text{W2} \leq 7 \text{0} \text{.0}$$
.

14. The toner according to claim 9, wherein the binder resin in the toner particle contains one or more kinds of units selected from units each represented by any one of the following formulae (4) to (6), and a total content ratio of the units each represented by any one of the formulae (4) to (6) in a total mass of the binder resin is 70 mass% or more: 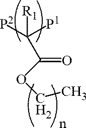
in the formula (4), P¹ and P² each represent a bonding site to a main chain skeleton of a resin, Ri represents a hydrogen atom or a methyl group, and “n” represents an integer of 0 or more and 30 or less; 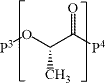
in the formula (5), P³ and P⁴ each represent a bonding site to the main chain skeleton of the resin; 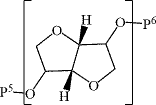
in the formula (6), P⁵ and P⁶ each represent a bonding site to the main chain skeleton of the resin.

15. The toner according to claim 14,
wherein the binder resin in the toner particle contains the unit represented by the formula (4), and
wherein the “n” in the formula (4) is 16 or more and 30 or less.

16. The toner according to claim 9, wherein, when color coordinates obtained by transforming emission wavelength spectra of the toner at a time of irradiation with excitation light at a wavelength of 250 nm or more and 290 nm or less and a wavelength of 315 nm or more and 400 nm or less into an L*a*b* color system are represented by G3 and G4, respectively, a difference ΔE2 between the color coordinates G3 and G4 is 20.0 or more.
